(19) United States
(12) Patent Application Publication
(10) Pub. No.: US 2009/0138621 A1
(43) Pub. Date: May 28, 2009

(54) SYSTEM AND METHOD FOR DELEGATING A DEPENDENT BUSINESS OBJECT

(76) Inventor: HERBERT HACKMANN, Wiesloch (DE)

Correspondence Address: SAP AG, 3410 HILLVIEW AVENUE, PALO ALTO, CA, 94304, US

(21) Appl. No.: 11/946,045

(22) Filed: Nov. 28, 2007

(51) Int. Cl. G06F 3/00

(52) U.S. Cl. 710/5

(57) ABSTRACT

Disclosed is a system and a method for delegating the object requests to a service provider class. For each request received at an object, the node identity of a node of the object is retrieved from the request. Based on this retrieved node identity, an instance of an object from the service provider class factory is fetched. If the retrieved node identity is regarding a dependent object then the request is delegated to a dependent business object service provider class. An instance of a service provider class of a node is fetched from a service provider class factory based on the node identity. The request is processed at the dependent business object by accessing a method in the service provider class of the object.

### FIELD OF THE INVENTION

Embodiments of the invention generally relate to the field of data processing system, more particularly to a way of providing centralized access to a business object of an enterprise software application.

### BACKGROUND OF THE INVENTION

A business object is a representation of a type of uniquely identifiable business entities described by a structural model, an internal process model, and one or more service interfaces. A business entity operates on the business objects. Examples of such business objects are “Sales Order” or “Purchase Order”. The development for the business objects is subdivided in the three phases; a design phase, a modeling phase and an implementation phase. During the design phase, the business objects are identified and named. During the modeling phase, a model editor is used to determine the structure of the business object. During the implementation phase, the service provider class uses generated proxy elements for inter business object communication. The different business objects are stores in the business object repository.

A business object typically contains one or more nodes. The nodes of the business object may be accessed by a service provider class. The service provider class provides basic functions such as create, retrieve, update, and delete on the business object and business object nodes. Typically, there would be only one service provider class that would provide access to the business object and all the business object nodes. Such a service provider class typically contains a significantly large amount of code since the service provider class has the code to access all the nodes in the business object.

For example, consider a business object that has ten nodes, and a service provider class that provides operations such as create, retrieve, update, and delete for all the ten nodes in the business object. Considering each of the operations would take at least 25 lines of code, and then the service provider class would typically have 100 lines of code for one node in the business object. For ten nodes, the service provider class would have 1000 lines of code. Maintaining a single service provider class for all the business object nodes is typically tedious and not efficient. It would be very time consuming for the developers of the service provider class to debug a problem in the service provider class with so many lines of code and if the problem is not debugged properly, the chances of a programming error being left out in the code may increase. Also, having a single service provider class that performs different operations on different nodes in different ways may not be a good object oriented design. Object oriented design recommends a modular approach in designing a solution to a problem. A modular approach such as breaking up one large service provider class into smaller service provider classes would typically decrease the problems faced in debugging. A modular approach would make it easier for the developers to debug a problem in the service provider class which is relatively smaller than one single service provider class for the business object.

The structure of a business object is defined by its nodes, their associations, their actions and the metadata. A service provider class for business object supports various consumers, such as the User Interface (UI), service interfaces and cross-business object communication.

A dependent object is a business object that becomes only viable through another business object. A dependent object represents a part of a business object that is reused by other business objects, but also provides an associated, reusable UI screen. Dependent objects are marked as such in the repository. Examples of dependent objects are business address, pricing document.

During modelling time, a dependent object association is simple to realise at the business object. At implementation time, a dependent object association results in an extensive and error-prone implementation of the business object service provider class. All requests regarding the dependent business object are passed to the business object service provider class and the business object service provider class has to delegate all the calls via the Local Client Proxy (LCP) delegation interface to the dependent object service provider class. The known method of LCP delegation is expensive and error-prone and hence this extensive LCP delegation work must be implemented in a generic way.

### SUMMARY OF THE INVENTION

Disclosed is a system and a method for delegating the object requests to a service provider class. For each request received at an object, the node identity of a node of the object is retrieved from the request. Based on this retrieved node identity, an instance of an object from the service provider class factory is fetched. If the retrieved node identity is regarding a dependent object then the request is delegated to a dependent business object service provider class. An instance of a service provider class of a node is fetched from a service provider class factory based on the node identity. The request is processed at the dependent business object by accessing a method in the service provider class of the object.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of a business object according to an embodiment of the invention.

FIG. 2 is a block diagram of a service provider class to access a business object according to an embodiment of the invention.

FIG. 3 is a flow diagram to access a business object using a service provider class according to an embodiment of the invention.

FIG. 4 is a flow diagram to access a dependent business object by using a service provider class according to an embodiment of the invention.

FIG. 5 is a block diagram of a service provider class to access a business object using a service provider class of a node according to an embodiment of the invention.

FIG. 6 is a system block diagram illustrating the various components of a system to access a business object using a service provider class of a node according to an embodiment of the invention.

FIG. 7 is an output screen that illustrates a tree structure of a single business object having a Root Node and one or more Sub-Node according to an embodiment of the invention.

### DETAILED DESCRIPTION

Disclosed is a system and a method for delegating the object requests to a service provider class. For each request received at an object, the node identity of a node of the object is retrieved from the request. Based on this retrieved node identity, an instance of an object from the service provider class factory is fetched. If the retrieved node identity is regarding a dependent object then the request is delegated to a dependent business object service provider class. An instance of a service provider class of a node is fetched from a service provider class factory based on the node identity. The request is processed at the dependent business object by accessing a method in the service provider class of the object.

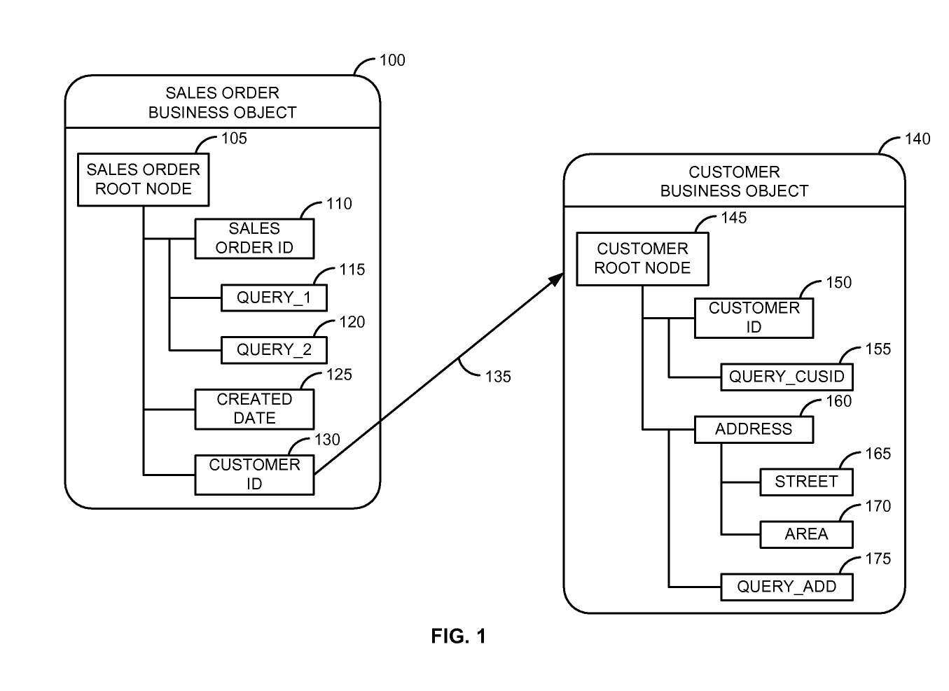

FIG. 1 is a block diagram of a business object according to an embodiment of the invention. An object represents a category of unique, identifiable business entities and hence the object can also be referred to as business object. Sales order business object 100 and customer business object 140 are two examples of business entities. The business object has one or more nodes which represent attributes or properties of the business object. Sales order business object 100 has nodes such as sales order root node 105, sales order ID 110, created date 125, and customer ID 130. Customer business object 140 has nodes such as customer root node 145, customer ID 150, and address 160. The hierarchy of the nodes is produced through associations between the nodes starting with the customer root node 145. Each node groups together semantically related attributes, for example, the node address 160 groups attributes such as street 165 and area 170. A node may also include a query, an association and a dependent object.

The node sales order ID 110 includes queries such as query_1 115 and query_2 120. Similarly, in customer business object 140, the node customer ID 150 includes query_cusid 155 and the node address 160 includes query_add 175. A query fetches data of a particular node based on a condition specified in the query. For example, in customer business object 140, query_add 175 on the node address 160 may fetch an address of a customer whose customer_ID 150 is specified in query_add 175.

The node customer ID 130 has an association 135 with customer business object 140. In a sales scenario, a sales order cannot exist without any customer assigned to the sales order. Thus, sales order business object 100 is associated with customer business object 140 and in particular, node customer ID 130 in sales order business object 100 has an association 135 with node customer ID 150 in customer business object 140.

A dependent object is a business object which can be used when embedded in another business object. For example, node address 160 in customer business object 140 is a dependent business object. An instance of the dependent business object cannot be created separately. The instance of the dependent business object can be created when the instance of the business object it is embedded in is created. The dependent business object may have zero or more embedded dependent business objects.

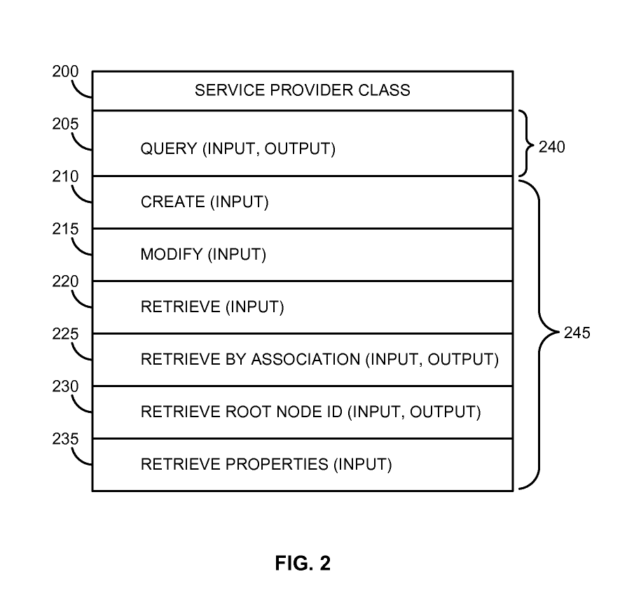

FIG. 2 is a block diagram of a service provider class to access a business object according to an embodiment of the invention. A service provider class 200 provides a set of services known as core services which provide direct access to the business object typically to manipulate data of the business object. The core services include query 205, create 210, modify 215, retrieve 220, retrieve by association 225, retrieve root node ID 230, and retrieve properties 235. The core services provided by service provider class 200 are derived from interface patterns such as query interface pattern 240 and access interface pattern 245 in enterprise service oriented architecture provided by SAP AG. Service oriented architecture (SOA) supports the design, development, identification and consumption of standardized software services across an enterprise, thereby improving reusability and flexibility of software components.

Query interface pattern 240 includes core service method query 240. Access interface pattern 245 includes core service methods such as create 210, modify 215, retrieve 220, retrieve by association 225, retrieve root node ID 230, and retrieve properties 235. A description of the methods of the service provider class 200 is given below:

### Methods of Service Provider Class

Query 205: Returns a list of node identifications (IDs) for a selection criteria specified in the input parameter of the method query 205. The method query 205 typically acts on data that is already persisted in a database.
Create 210: The method create 210 is a mode of the method Modify 215 which creates a new business object node element of the node ID specified in the input parameter of the method create 210.
Modify 215: The method modify 215 performs actions like creating, updating, and deleting data. Modify 215 typically performs all requested data changes on transaction data that are in a temporary buffer and not persisted in a database.
Retrieve 220: The method retrieve 220 returns a node ID and a list of node elements for the node ID specified in the input parameter of the method retrieve 220. Retrieve 220 typically works on transactional data that is in a temporary buffer.
Retrieve by association 225: The method retrieve by association 225 returns dependent data that results from a specified association for a node ID specified in the input parameter of the method retrieve by association 225.
Retrieve root node ID 230: The method retrieve root node ID 230 returns an instance of a root node of a business object instance specified in the input parameter of the method retrieve root node ID 230.
Retrieve properties 235: The method retrieve properties 235 retrieves settings of properties for a node ID specified in the input parameter of the method retrieve properties 235.

The methods of the service provider class 200 described above contain one or more input parameters and zero or more output parameters. Service provider class 200 may be registered for a node in the business object. In one embodiment, there may be one service provider class registered for every node, query, and association in the business object. In another embodiment, a service provider class may be registered for only few nodes in the business object. The rest of the nodes in the business object may be accessed via a default service provider class.

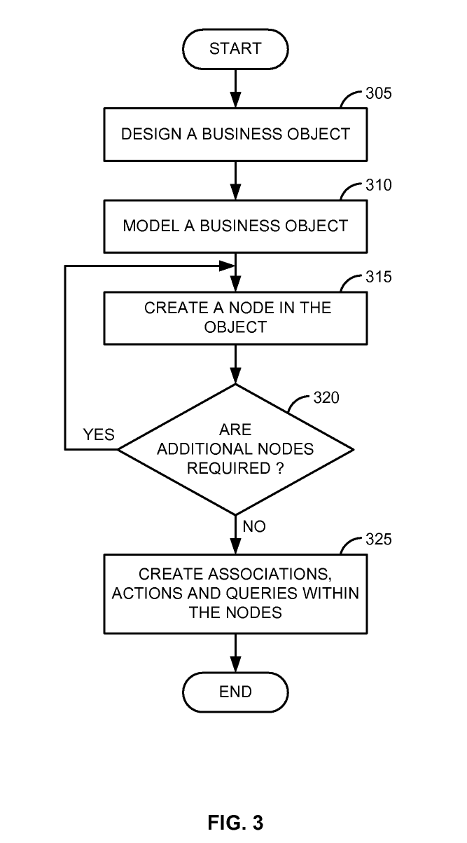

FIG. 3 is a flow diagram to access a business object using a service provider class, according to an embodiment of the invention. At 305, a business object is designed, such a design includes using pre-determined naming convention to name the business objects. At 310, a business object is modeled whereby its structure is defined. At 315, a node is created in the business object. At 320, the additional nodes are continued to be created in the business object until no additional nodes are required. At 325, the associations, actions and queries within the nodes are created.

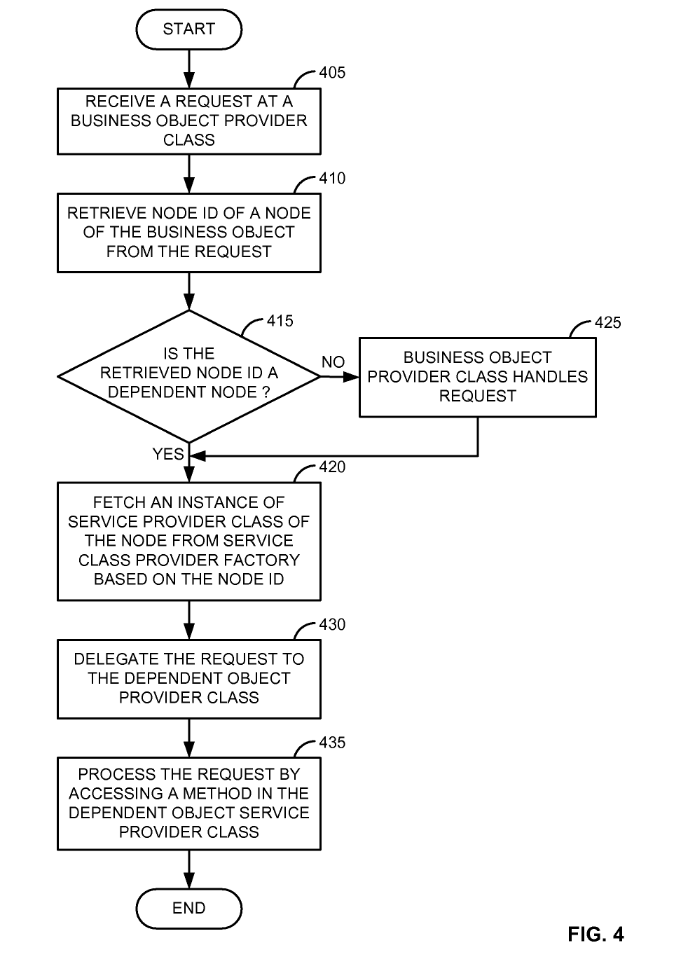

FIG. 4 is a flow diagram to access a dependent business object using a service provider class according to an embodiment of the invention. At 405, a request is received at the object. At 410, the node identity of a node of the business object is retrieved from the request. At 415, if the retrieved node identity is relating to a dependent object then at 420 an instance of the service provider class from the service provider class factory is fetched. At 415, if the retrieved node identity is not relating to a dependent object, then the business object provider class handles the request at 425. At 430, the request is delegated to a dependent object service provider class. At 435, the request accesses a method in the dependent object service provider class.

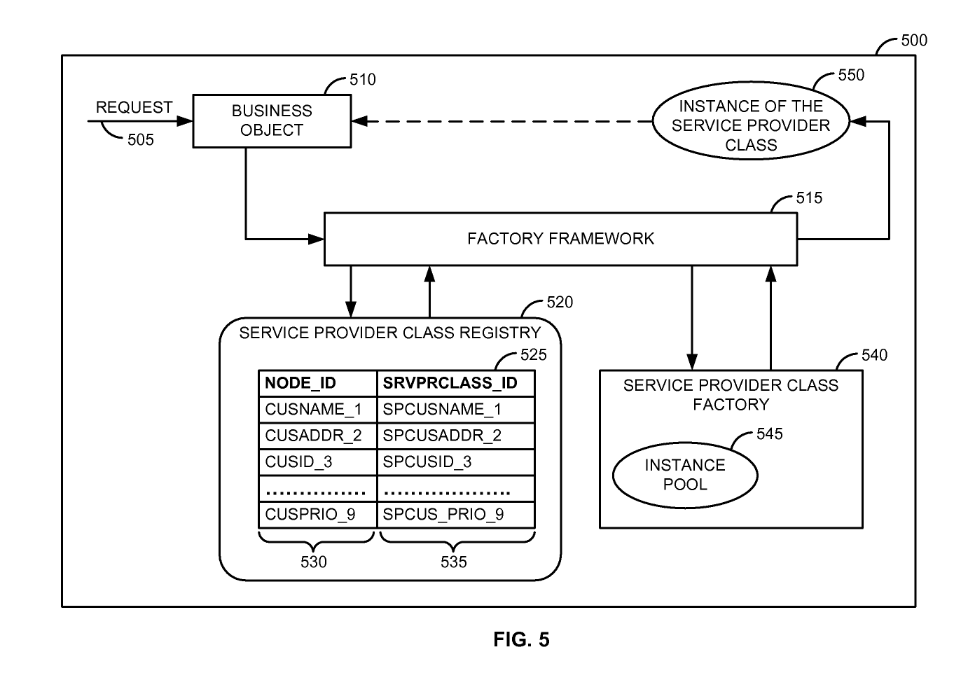

FIG. 5 is a block diagram of a system to access a business object using a service provider class of a node according to an embodiment of the invention. System 500 includes a business object 510 at which request 505 is received. The request 505 may include a query, create, update, or delete operation on a node of business object 510. Node identification (ID) of the node in business object 510 is retrieved from request 505. Node ID may include a query ID, an association ID, or a dependent object ID. A service provider class 200 as shown in FIG. 2 may be registered for the node in service provider class registry 520.

Service provider class registry 520 has a table 525 that contains registrations of service provider classes for the nodes. Table 525 contains a list of node IDs 530 and corresponding service provider class ID 535 of the service provider classes registered for the node IDs 530. The node which does not have a service provider class 200 registered may be accessed by a default service provider class. The default service provider class provides methods to access the node of the business object which does not have the service provider class registered in the service provider class registry 520.

Factory framework 515 receives node ID from business object 510 and checks service provider class registry 520 if service provider class 200 is registered for node ID. If service provider class 200 is registered for node ID, then factory framework 515 fetches the service provider class ID of the service provider class 200 from service provider class registry 520. Factory framework 515 then fetches an instance of the service provider class 550 from service provider class factory 540 based on service provider class ID. If there is no service provider class 200 registered for node ID, then factory framework 515 fetches an instance of a default service provider class 550 from the service provider class factory 540. The service provider class factory 540 fetches the instance of service provider class from an instance pool 545 where an instance of service provider class is stored. If the instance of the service provider class 550 does not exist in instance pool 545, then service provider class factory 540 creates an instance of the service provider class 550 in instance pool 545. The instance of the service provider class 550 has methods that include query 205, create 210, modify 215, retrieve 220, retrieve by association 225, retrieve root node ID 230 and retrieve properties 235 as shown in FIG. 2. Request 505 at business object 510 may be processed by accessing a method from instance of the service provider class 550.

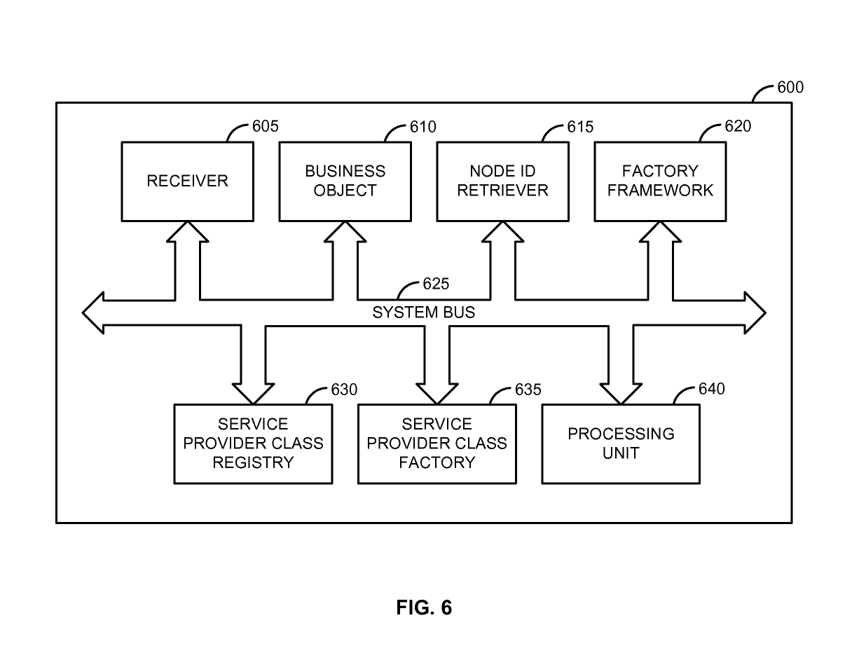

FIG. 6 is a system block diagram of various components of a system to access a business object using a service provider class of a node according to an embodiment of the invention. System 600 includes various components such as receiver 605, business object 610, node ID retriever 615, factory framework 620, service provider class registry 630, service provider class factory 635, and processing unit 640 all electronically coupled to system bus 625. One skilled in the art will appreciate that the above components may be connected to each other in any other manner so as to achieve the same result as the one achieved by the components in this figure. Receiver 605 receives the request at business object 610. The request is passed to node ID retriever 615 to retrieve a node ID from the request. The node ID is then passed to factory framework 620 to fetch a service provider class for the node ID. Factory framework 620 checks service provider class registry 630 if a service provider class is registered for the node ID. If the service provider class is registered for the node ID, then the factory framework 620 fetches a service provider class ID of the service provider class registered for the node ID from service provider class registry 630. Factory framework 620 then fetches an instance of the service provider class from the service provider class factory 635 based on the service provider class ID. If the service provider class is not registered for the node ID in service provider class registry 630, then factory framework 620 fetches an instance of a default service provider class from the service provider class factory 635. The processing unit 640 receives the instance of the service provider class and processes the request on business object 610 by accessing a method in the instance of the service provider class.

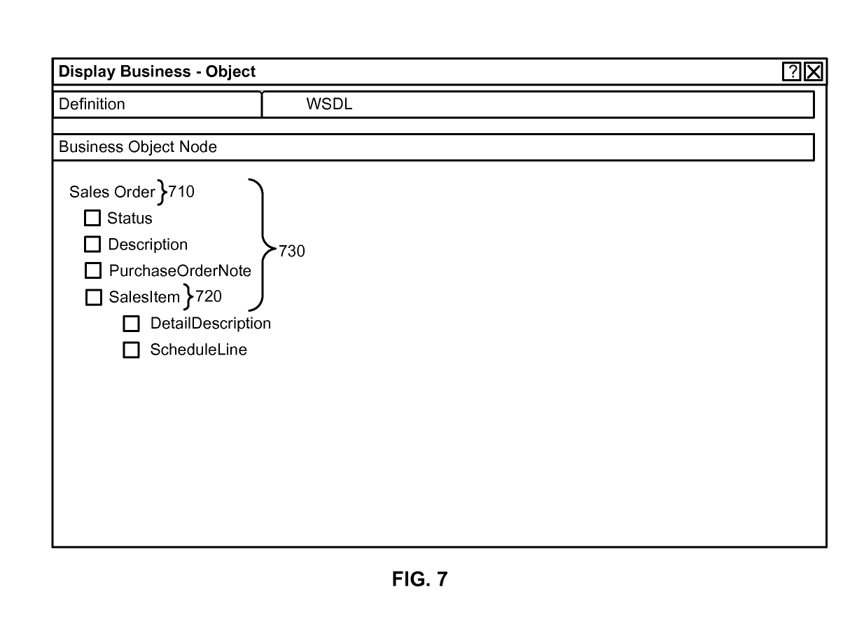

FIG. 7 is an output screen that illustrates a tree structure of a single business object having a Root Node and one or more Sub-Node according to an embodiment of the invention. As illustrated the output screen defines a tree structure of a single business object where each business object has one particular Root Node for example SalesOrder 710, the “anchor” of the business object structure and one or more Sub Nodes for example SalesItem 720. Further nodes are tied in with existing nodes at 730. The business objects offer service interfaces with operations, which provide access to the business object. Interfaces can be on object level as well as on node level.

Other embodiments of the invention may be implemented in digital electronic circuitry, or in computer hardware, firmware, software, or in combinations of them.

Elements of the invention may also be provided as a machine-readable medium for storing the machine-executable instructions. The machine-readable medium may include, but is not limited to, Flash memory, optical disks, CD-ROMs, DVD ROMs, RAMs, EPROMs, EEPROMs, magnetic or optical cards, propagation media or other type of machine-readable media suitable for storing electronic instructions.

Throughout the foregoing description, for the purposes of explanation, numerous specific details were set forth in order to provide a thorough understanding of the invention. It will be apparent, however, to one skilled in the art that the invention may be practiced without some of these specific details. The underlying principles of the invention may be employed using a virtually unlimited number of different types of input data and associated actions.

Accordingly, the scope and spirit of the invention should be judged in terms of the claims and equivalents which follow.

What is claimed is:

1. A method, comprising:
receiving a request at an object;
retrieving a node identity of a node of the object from the request;
fetching an instance of a service provider class of the node from a service provider class factory based on the node identity;
fetching a dependent object service provider class of a dependent object from the service provider class factory;
delegating the request to the dependent object service provider class; and
processing the request at the dependent object by accessing a method in the dependent object service provider class.

2. The method in claim 1, wherein the object comprises a business object.

3. The method in claim 1, further comprising registering the service provider class of the node from a service provider class registry.

4. The method in claim 1, further comprising associating the object to the dependent object.

5. The method in claim 1, further comprising checking whether a requested node is the dependent node.

6. The method in claim 1, wherein the node of the object comprises an entity selected from a group consisting of a query on the node, an association of the node with another object, an attribute, and a dependent object.

7. The method in claim 1, wherein fetching the instance of the service provider class of the node comprises:
checking the service provider class registry for the service provider class of a node based on the node identity;
fetching a service provider class identity of the service provider class of a node from the service provider class registry based on the node identity; and
fetching the instance of the service provider class from the service provider class factory based on the service provider class identity.

8. The method in claim 1, wherein fetching the instance of the service provider class of the node from the service provider class factory comprises fetching the instance of the service provider class from an instance pool in the service provider class factory.

9. The method in claim 1, further comprising creating the instance of the service provider class of a node if the instance of the service provider class of a node does not exist in an instance pool.

10. The method in claim 1, wherein processing the request at the object by accessing a method in the service provider class of the node comprises accessing a core service selected from a group consisting of create, retrieve, retrieve by association, update, and delete provided by the object.

11. A system, comprising:
a receiver to receive a request at an object;
a node identity retriever electronically coupled to the receiver, to retrieve a node identity of a node of the object from the request;
a factory framework electronically coupled to the receiver and the node identity retriever to fetch an instance of a service provider class of the node from a service provider class factory based on the node identity; and
a processing unit electronically coupled to the receiver, the node identity retriever and to the factory framework, the processing unit to process the request at the object by accessing a method in the service provider class.

12. The system in claim 11, wherein the service provider class factory further comprises an instance pool electronically coupled to the service provider class factory that contains an instance of the service provider class of the node.

13. The system in claim 10, further comprising a service provider class registry electronically coupled to the factory framework and service provider class factory to register the service provider class of the node.

14. The system in claim 10, where in the object, the node identification retriever, the factory framework, the service provider class factory, the processing unit, and a service provider class registry are electronically coupled to a system bus.

15. An article of manufacture, comprising:
a machine readable medium having instructions which when executed by a machine cause the machine to:
receive a request at an object;
retrieve a node identity of a node of the object from the request;
fetch an instance of a service provider class of the node from a service provider class factory based on the node identity;
fetch a dependent object service provider class of a dependent object from the service provider class factory;
delegate the request to the dependent object service provider class; and
process the request at the dependent object by accessing a method in the dependent object service provider class.

16. The article of manufacture in claim 15, wherein the machine readable medium provides instructions, which when executed by a machine cause the machine to:
check the service provider class registry for the service provider class of a node based on the node identity;
fetch a service provider class identity of the service provider class of as node from a service provider class registry based on the node identity; and
fetch the instance of the service provider class from the service provider class factory based on the service provider class identity.

17. The article of manufacture in claim 15, wherein the machine readable medium provides instructions, which when executed by a machine cause the machine to fetch the instance of the service provider class from an instance pool in the service provider class factory.

18. The article of manufacture in claim 15, wherein the machine readable medium provides instructions, which when executed by a machine cause the machine to access a core service selected from a group consisting of create, retrieve, retrieve by association, update, and delete provided by the object for the node.
